(19) United States
(12) Patent Application Publication
(10) Pub. No.: US 2022/0133598 A1
(43) Pub. Date: May 5, 2022

(54) EMSIS BAG

(71) Applicants: RYAN DEPASQUAL, New Braunfels, TX (US); CHRISTINE DEPASQUAL, New Braunfels, TX (US)

(72) Inventors: RYAN DEPASQUAL, New Braunfels, TX (US); CHRISTINE DEPASQUAL, New Braunfels, TX (US)

(21) Appl. No.: 17/518,189

(22) Filed: Nov. 3, 2021

Related U.S. Application Data
(60) Provisional application No. 63/109,751, filed on Nov. 4, 2020.

(51) Int. Cl. A61J 19/00

(52) U.S. Cl. CPC A61J 19/00

(57) ABSTRACT

An emesis bag includes a multifaceted flexible triangular mouthpiece to both hold the emesis bag open and to comfortably accommodate a user's mouth and nose. The emesis bag further includes a closure band and mouthpiece notch/slot for securely closing the bag for sanitary disposal.

### CROSS-REFERENCE TO RELATED APPLICATIONS

This application claims priority to provisional application Ser. No. 63/109,751 titled “Emesis Bag,” which is incorporated herein in its entirety by reference.

### FIELD OF INVENTION

This invention generally relates to emesis bags.

### BACKGROUND OF THE INVENTION

Various mechanical means have been proposed to contain emesis for sanitary disposal. A common feature of previous emesis bags is a closure to close the top of the bag. A common problem associated with previous emesis bags is that such closures are awkward to close or are prone to coming lose and releasing contents or odors. Similarly, prior emesis bags present rigid and uncomfortable mouthpieces. Accordingly, improvements are sought in closing emesis bags for sanitary disposal.

### SUMMARY OF THE INVENTION

While the way that the present invention addresses the disadvantages of the prior art will be discussed in greater detail below, in general, the present invention provides an emesis bag with a pliable triangular mouthpiece disposed at the top of the emesis bag and a closure band.

A disposable bag serves as a receptacle for the collection of emesis, and is equipped with a convenient closure ribbon placed below the opening of the bag to improve closure after use. The invention uses a flexible triangular-shaped frame as a mouthpiece or “entry point” attached to the bag creating a “biased open” opening for the bag. This triangular shaped mouthpiece allows for a closer, more comfortable, ergonomic fit to the face of the user. The triangular shape accommodates both the mouth and nose of the user. The shape and pitch of the mouthpiece allows for a more direct entry of foreign material into the bag thus minimizing the chance of splashing or spillage and maximizing infection control. The shape also serves a grip or collar to provide stability for the user when held.

A ribbon or band attached to the bag below the triangle opening offers a more secure closure system to minimize spillage of hazardous waste and improve concealment of odors. A ribbon, string, drawstring, or other tying or constrictive feature is attached to or disposed around the bag below the biased triangle opening of the bag near the mouthpiece to allow the user a simple and more effective way to secure the bag closed immediately after use. This can be accomplished by cinching the ribbon using a drawstring technique or by firmly wrapping and securing the attached ribbon, e.g., with an adhesive at one end of the ribbon. After the ribbon has been tightly secured around the bag and once the backing on the adhesive has been removed, the adhesive end of the ribbon is also attached to the bag or to the mouthpiece. This provides a secure closure of the bag to the minimize hazardous waste spillage, infection, and odors, thus improving overall sanitary conditions during the use of the product and after disposal. A secure closure allows for adequate time to properly dispose of the bag.

In addition to, or as an alternate configuration, a slot is defined in at least one side portion of the mouthpiece and can be conveniently used to further cinch the bag after the ribbon has been firmly secured around the bag, e.g., by sliding the secured bag into the slot. The additional slot closure function offers an added level of sanitary security to the bag in turn maximizing sanitary conditions for the user and general purposes.

The overall sizes of the bag and mouthpiece offer advantages over existing emesis bags in the marketplace and can be used for many situations. The mouthpiece itself is unique in its triangular ergonomic design, being rigid enough to bias the bag open but flexible enough to conform to the face of the user during use. The pliability of the bag allows for a compact size, in turn, allowing for storage of a large unused quantity in small spaces for convenience. The added closure ribbon on the bag allows the user to have an added confidence in using, handling, and disposing of the product.

In some embodiments the pliable, flexible triangular mouthpiece comprises an ABS plastic collar, frame, ring, or other suitably pliable and self-supporting structure.

In some embodiments, the sidewalls of the emesis bag comprise HDPE, which can readily accommodate printing such as the volume gradient.

This results in a comfortable, convenient, sanitary emesis bag with multiple closure features.

One aspect of the invention features, in some embodiments, an emesis bag including a bag body having sidewalls and defining an opening at the top of the bag body; a mouthpiece dispose at the opening of the bag body; and a closure feature adjacent the mouthpiece for securing the bag body in a closed position.

In some embodiments, the closure feature includes a tie attached at one end to the bag body with a free end of the tie extending to be wrapped around the bag body in the closed position.

In some embodiments, the closure feature includes a slot defined by the mouthpiece and sized to receive a twisted portion of the bag body therein to secure the bag body in the closed position.

In some embodiments, the mouthpiece is configured as a triangle sized to fit over the nose and mouth of a user. In some embodiments, the mouthpiece is formed of a plastic material sufficiently stiff to bias the bag body opening in an open position and sufficiently pliable to comfortably conform to the face of a user.

Another aspect of the invention features, in some embodiments, an emesis bag including a bag body defining a bag opening, a mouthpiece disposed at the bag opening and configured to bias the bag opening in an open position; and a bag retainer disposed near the bag opening to secure the bag in a closed position.

In some embodiments, the bag retainer comprises a slot defined in the mouthpiece to receive a portion of the bag body therein in a closed position.

In some embodiments, the mouthpiece is configured as a rounded triangle sized to fit over the mouth and nose of a user and is sufficiently stiff to bias the bag opening in an open position and sufficiently pliable to conform to the face of the user.

### BRIEF DESCRIPTION OF THE DRAWINGS

A more complete understanding of the present invention may be derived by referring to the detailed description and claims when considered in connection with the Figures, wherein like reference numerals refer to similar elements throughout the Figures, and

FIG. 1 illustrates a front view of an emesis bag according to one embodiment having a closure around an upper portion;

FIG. 2 illustrates a left side view of the emesis bag of FIG. 1.

FIG. 3 illustrates a right side view of the emesis bag of FIG. 1;

FIG. 4 illustrates a top view of the emesis bag of FIG. 1, having a mouthpiece at an upper end;

FIG. 5 illustrates a top perspective view of the mouthpiece of FIG. 4.

FIG. 6 illustrates a top view of the mouthpiece of FIG. 4;

FIG. 7 illustrates a top perspective view of the mouthpiece of FIG. 4;

FIG. 7 illustrates a left side view of the mouthpiece of FIG. 4;

FIG. 8 illustrates a right side view of the mouthpiece of FIG. 4; and

FIG. 9 illustrates a rear view of the emesis bag of FIG. 1, having a volume indicator scale.

### DETAILED DESCRIPTION

The following description is of exemplary embodiments of the invention only, and is not intended to limit the scope, applicability or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, closure mechanisms and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

In the following description, certain terminology is used to describe features of one or more embodiments of the invention. For example, the term “mouthpiece” as described herein may include a collar, frame, or ring having sufficient structure to bias or maintain the emesis bag opening open. The mouthpiece may be constructed from a wide variety of materials including, but not necessarily limited to ABS, and is preferably sufficiently pliable to conform somewhat when quickly pressed against the users face and over the mouth during use.

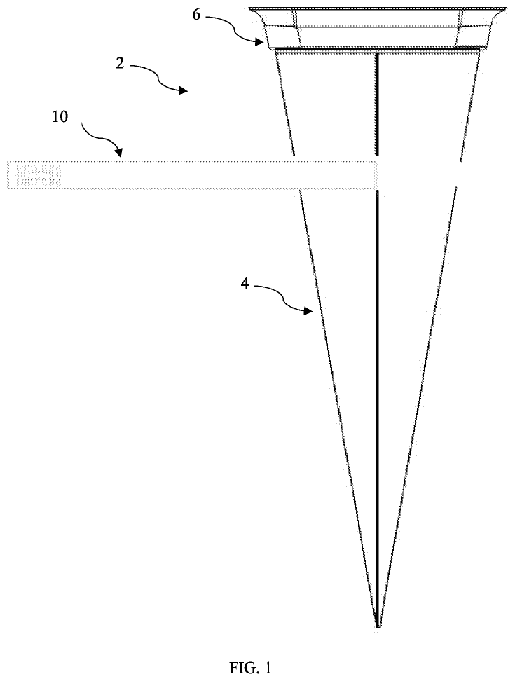

With reference to FIGS. 1-4, different views of an emesis bag illustrate various features of the invention. With reference now to FIG. 1, an emesis bag 2 according to one embodiment of the present invention includes a bag body 4 and a flexible mouthpiece 6 disposed at the bag opening 8 to bias bag 2 in a ready, open position. A closure band 10 disposed below mouthpiece 6 serves to securely close emesis bag 2 after use, e.g., by adhesion of band 10 to bag body 4 in a closed, e.g., twisted closed, arrangement. A slot or notch 12 defined in mouthpiece 6 serves as a secondary closure feature, or security closure, by receiving the twisted bag body therein.

A ribbon or tie 14 is attached or disposed on bag body 4 near mouthpiece 6 to serve as a closure to bag body 4. Tie 14 ay include adhesives to maintain the tie constricted about bag body 4. Any other suitable closure structure may be used, e.g., wire twist ties, touch fasteners, elastics etc.

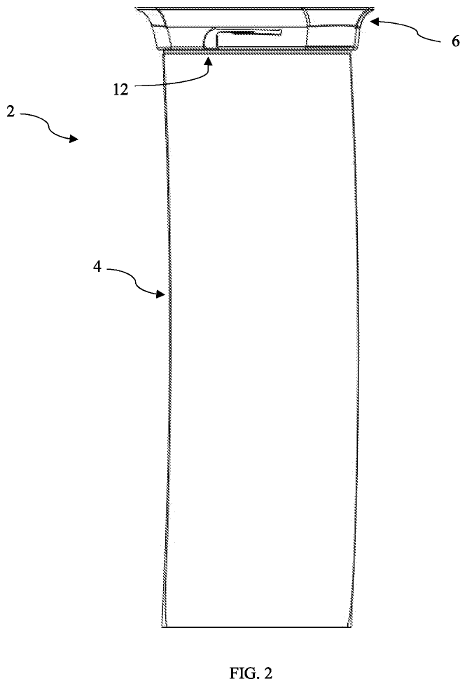

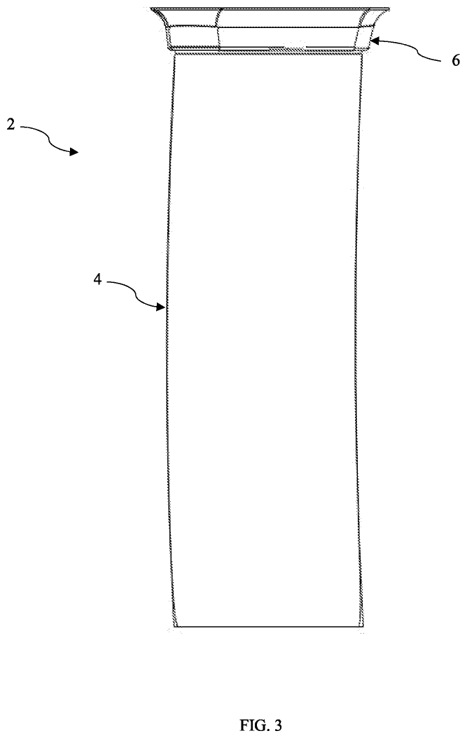

With reference now to FIGS. 2-3, left and right views of emesis bag 2 shows slot 12, defined in mouthpiece 6 for securing the twisted bag closed.

With reference now to FIG. 4, a top view of flexible mouthpiece 6 is shown according to one embodiment. Mouthpiece 6 may be made of plastic or other suitably rigid and pliable material selected to provide structure to bias the opening of bag 2 open and to conform to the face of the user.

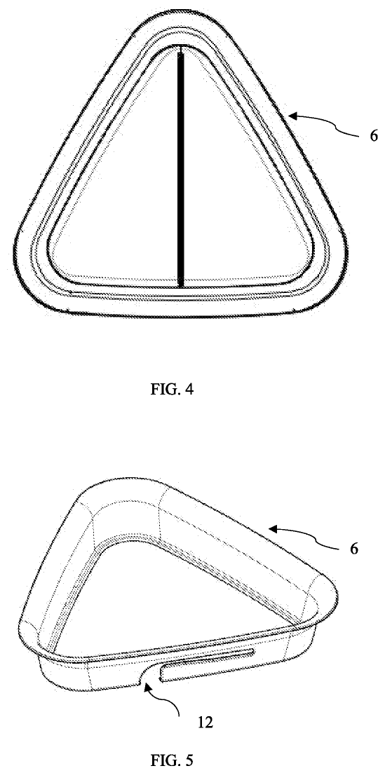

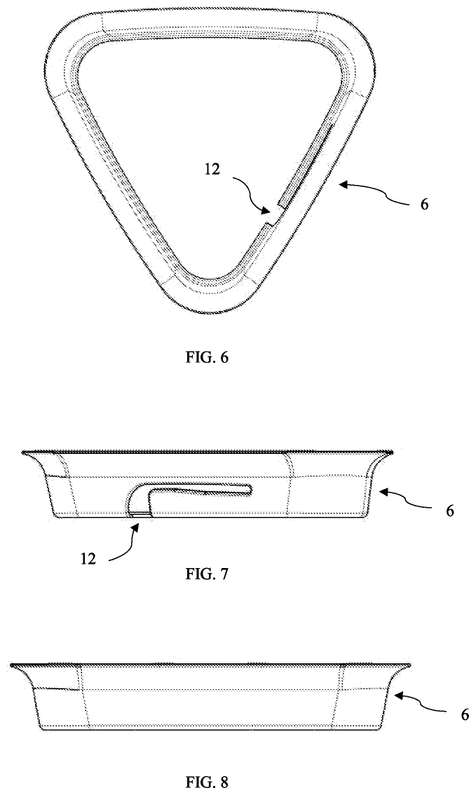

FIGS. 5-8 illustrate various views of the mouthpiece shown in FIG. 4. Slot 12 defined in mouthpiece 6 serves to secure bag 2 in closed position, e.g., when twisted. In some embodiments, mouthpiece 6 is configured generally as a rounded triangle to fit over the nose of the user at the apex and about the mouth and chin.

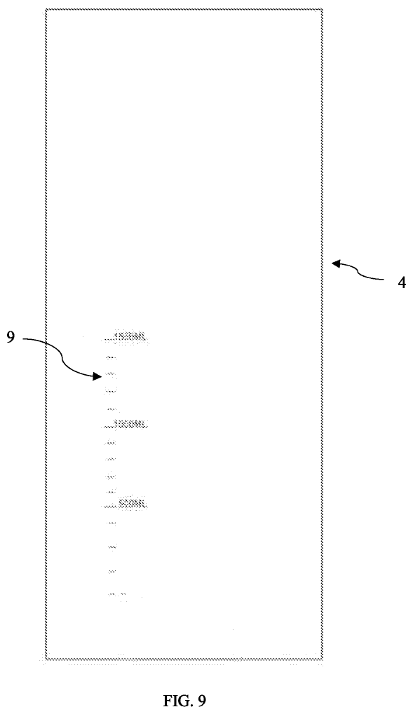

With reference now to FIG. 9, a rear view of the emesis bag of FIG. 1 is shown having a volume indicator scale printed thereon.

Similarly, while the present invention has been described herein as an emesis bag with a mouthpiece and closure, aspects of the present invention may be readily used with any number of other emesis bag configurations or other similar devices now known or hereafter developed.

Finally, while the present invention has been described above with reference to various exemplary embodiments, many changes, combinations and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

1. An emesis bag comprising:
a bag body having sidewalls and defining an opening at the top of the bag body;
a mouthpiece dispose at the opening of the bag body; and
a closure feature adjacent the mouthpiece for securing the bag body in a closed position.

2. The emesis bag of claim 1, wherein the closure feature comprises a tie attached at one end to the bag body with a free end of the tie extending to be wrapped around the bag body in the closed position.

3. The emesis bag of claim 1, wherein the closure feature comprises a slot defined by the mouthpiece and sized to receive a twisted portion of the bag body therein to secure the bag body in the closed position.

4. The emesis bag of claim 1, wherein the mouthpiece is configured as a triangle sized to fit over the nose and mouth of a user.

5. The emesis bag of claim 1, wherein the mouthpiece is formed of a plastic material sufficiently stiff to bias the bag body opening in an open position and sufficiently pliable to comfortably conform to the face of a user.

6. An emesis bag comprising:
a bag body defining a bag opening,
a mouthpiece disposed at the bag opening and configured to bias the bag opening in an open position; and
a bag retainer disposed near the bag opening to secure the bag in a closed position.

7. The emesis bag of claim 6, wherein the bag retainer comprises a slot defined in the mouthpiece to receive a portion of the bag body therein in a closed position.

8. The emesis bag of claim 6, wherein the mouthpiece is configured as a rounded triangle sized to fit over the mouth and nose of a user and is sufficiently stiff to bias the bag opening in an open position and sufficiently pliable to conform to the face of the user.
